(19) United States
(12) Patent Application Publication
(10) Pub. No.: US 2016/0205485 A1
(43) Pub. Date: Jul. 14, 2016

(54) ELECTRONIC DEVICE AND METHOD FOR DETECTING AN ACCESSORY OF THE ELECTRONIC DEVICE

(71) Applicant: Chiun Mai Communication Systems, Inc., New Taipei (TW)

(72) Inventor: CHENG-PING LIU, New Taipei (TW)

(21) Appl. No.: 14/960,665

(22) Filed: Dec. 7, 2015

(30) Foreign Application Priority Data
Jan. 10, 2015 (CN) 201510011037.9

(51) Int. Cl. H04R 29/00; H04R 1/10

(52) U.S. Cl. CPC H04R 29/00; H04R 1/1041; H04R 2420/05

(57) ABSTRACT

In an accessory detection method for an electronic device, a bias voltage is provided to power a chip of an accessory when the accessory is inserted into an audio jack of the electronic device. An initialization command with a preset format is sent to the chip. The electronic device waits for an accessory identifier (AID) of the accessory from the chip. When the electronic device receives the AID of the accessory from the chip, a set of acoustic parameters corresponding to the received AID of the accessory is generated. The method controls the electronic device to apply the generated set of acoustic parameters.

### CROSS-REFERENCE TO RELAYED APPLICATIONS

This application claims priority to Chinese Patent Application No. 201510011037.9 filed on Jan. 10, 2015, the contents of which are incorporated by reference herein.

### FIELD

The subject matter herein generally relates to device detection technology, and particularly to an electronic device and method for detecting an accessory of the electronic device.

### BACKGROUND

When a headset is inserted into a headset jack of an electronic device, the electronic device can only detect the insertion of the headset. However, the electronic device cannot determine what type of headset is inserted. Thus, no matter which type of headset is inserted, the electronic device uses a same set of digital signal processing (DSP) acoustic parameters for the headset. Sometimes, the same set of DSP acoustic parameters cannot be suitable for different headsets to achieve perfect sound effects.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a diagrammatic view of a connection between the electronic device and a chip of an accessory.

FIG. 3 is a block diagram of an example embodiment of an accessory detection system in the electronic device of FIG. 1.

FIG. 4 is a flowchart of an example embodiment of a method for detecting an accessory of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

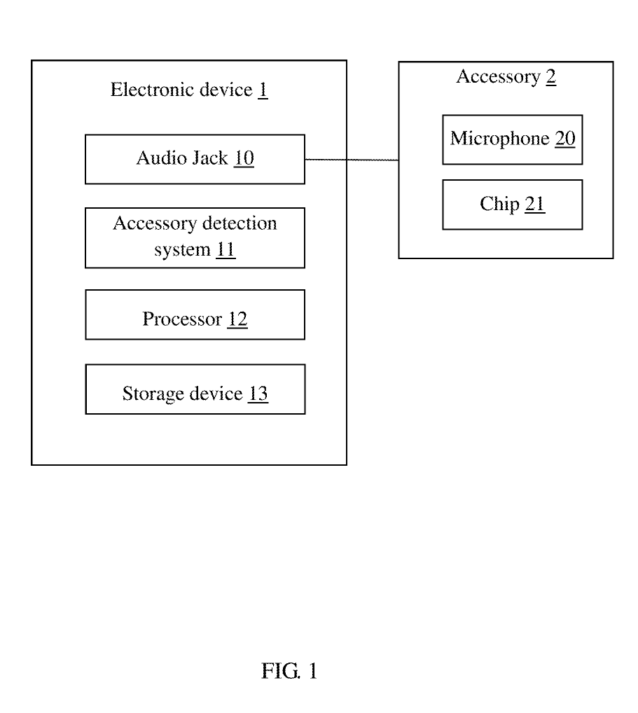

FIG. 1 illustrates a block diagram of an example embodiment of an electronic device. In at least one embodiment as shown in FIG. 1, an electronic device 1 can include, but is not limited to, an audio jack 10, an accessory detection system 11, at least one processor 12, and a storage device 13. FIG. 1 illustrates only one example of the electronic device 1, other examples can comprise more or fewer components than those shown in the embodiment, or have a different configuration of the various components.

The at least one processor 12 executes one or more computerized codes and other applications of the electronic device 1 to provide functions of the electronic device 1. The storage device 13 can be an internal storage device, such as a random access memory (RAM) for temporary storage of information, and/or a read only memory (ROM) for permanent storage of information. The storage device 13 can also be an external storage device, such as an external hard disk, a storage card, or a data storage medium.

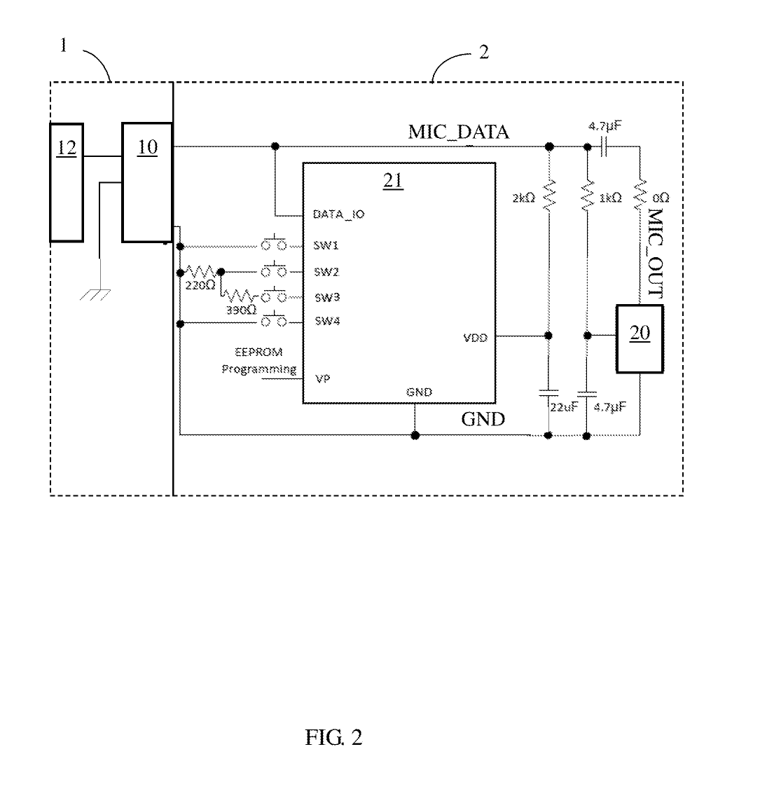

In at least one embodiment, the electronic device 1 may connect to an accessory 2 (for example, a headset) through the audio jack 10. The accessory 2 can be inserted into the audio jack 10 to connect the electronic device 1. The accessory 2 can include, but is not limited to, a microphone 20 and a chip 21. The chip 21 can be a 1-wire chip, or a Peripheral Interface Controller (PIC) chip. In at least one embodiment, the connection between the electronic device 1 and the accessory 2 can be shown in FIG. 2.

When the accessory 2 is inserted into the audio jack 10, a “DATA_IO” pin of the chip 21 can connect to a microphone pin (not shown in FIG. 2) of the audio jack 10, and the chip 21 is powered by a “MICBIAS” pin of the electronic device 1. The microphone pin of the audio jack 10 connects to the at least one processor 12 of the electronic device 1. The microphone pin of audio jack 10 further connects to an audio decoder (not shown in FIG. 2) of the electronic device 1, to execute a decoding process of data output from the microphone 20.

In at least one embodiment, the chip 21 of the accessory 2 stores an accessory identifier (hereinafter referred as “AID”) of the accessory 2. The AID of the accessory 2 can be preset according to a model or other parameters of the accessory 2. The AIDs of the accessories 2 with the same model can be the same, and the AIDs of the accessories 2 with different models can be different. In at least one embodiment, the storage device 13 of the electronic device 1 stores AIDs of a plurality of accessories 2 with different models, and further stores a set of acoustic parameters (for example, digital signal processing (DSP) acoustic parameters) corresponding to each of the AIDs. There is a one-to-one correspondence relation between the AIDs and the sets of acoustic parameters stored in the storage device 13. The acoustic parameters are optimal parameters that are predefined according to acoustic characteristics of the accessories 2 with different models. For example, the acoustic parameters can include, but is not limited to, sound effects, or equalizer, for example.

In at least one embodiment, the accessory detection system 11 can identify the accessory 2 which is inserted into the audio jack 10, and apply optimal acoustic parameters corresponding to the accessory 2.

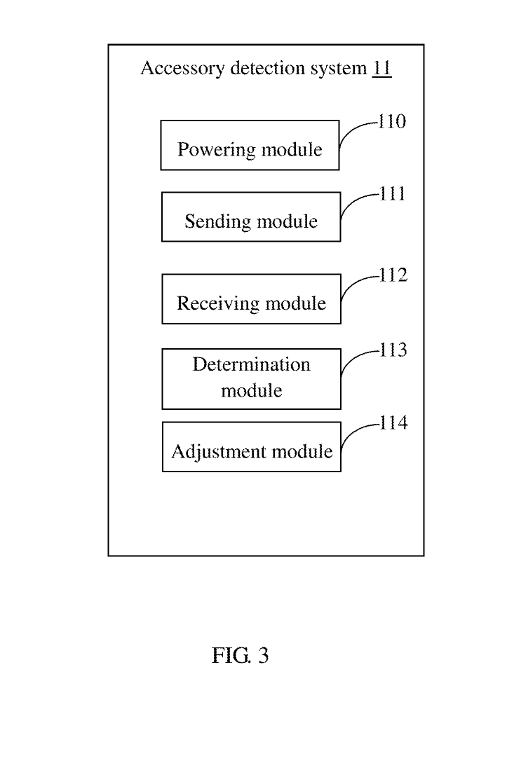

FIG. 3 illustrates a block diagram of an example embodiment of an accessory detection system in the electronic device of FIG. 1. In at least one embodiment, the accessory detection system 11 can include, but is not limited to, a powering module 110, a sending module 111, a receiving module 112, a determination module 113, and an adjustment module 114. The modules 110-114 can include computerized instructions in the form of one or more computer-readable programs that can be stored in a non-transitory computer-readable medium, such as the storage device 13, and be executed by the at least one processor 12 of the electronic device 1.

The powering module 110 provides a bias voltage to the chip 21 of the accessory 2 for powering the chip 21, when the accessory 2 is inserted into the audio jack 10. In at least one embodiment, the powering module 110 can enable the “MICBIAS” pin of the electronic device 1 to provide the bias voltage to the chip 21.

The sending module 111 sends an initialization command to the chip 21. The initialization command can have a preset format. For example, the initialization command can include a command type (Cmd Type) field, a response time field, an operation mode field, an interrupt delay field, and a reserve field. When the command type field is set to be the value of “00”, which indicates that the electronic device 1 sends the initialization command. In other embodiments, the sending module 111 can send the initialization command after the chip 21 is steady. For example, the sending module 111 can delay a preset time period (for example, 80 milliseconds), and then send the initialization command.

The receiving module 112 waits for an accessory identifier (AID) of the accessory 2 from the chip 21. After the chip 21 receives the initialization command from the electronic device 1, the chip 21 can read the AID of the accessory 2, and feeds back the AID with a preset format to the electronic device 1.

The determination module 113 determines whether the electronic device 1 receives the AID of the accessory 2 from the chip 21. In at least one embodiment, the determination module 113 determines whether the electronic device 1 receives the AID from the chip 21 in a preset time period (for example, 20 milliseconds). If the electronic device 1 receives the AID from the chip 21 within the preset time period, the determination module 113 determines that the electronic device 1 receives the AID of the accessory 2 from the chip 21. If the electronic device 1 does not receive the AID from the chip 21 within the preset time period, the determination module 113 determines that the electronic device 1 does not receive the AID of the accessory 2 from the chip 21.

After the electronic device 1 receives the AID of the accessory 2 from the chip 21, the adjustment module 114 generates a set of acoustic parameters corresponding to the received AID of the accessory 2, and controls the electronic device 1 to apply the generated set of acoustic parameters. In at least one embodiment, the adjustment module 114 searches for a specified AID from the storage device 13 which matches (for example, be the same as) the received AID. If the adjustment module 114 finds the specified AID from the storage device 13, the adjustment module 114 selects the set of acoustic parameters corresponding to the specified AID for generating the set of acoustic parameters corresponding to the received AID. If the adjustment module 114 does not find the specified AID from the storage device 13, the adjustment module 114 selects a default set of acoustic parameters for generating the set of acoustic parameters corresponding to the received AID. The electronic device 1 applies the generated set of acoustic parameters to process audio data of the electronic device 1.

After the electronic device 1 is determined not to receive the AID of the accessory 2 from the chip 21, the adjustment module 114 controls the electronic device 1 to apply a preset set of acoustic parameters. The electronic device 1 applies the preset set of acoustic parameters to process audio data of the electronic device 1.

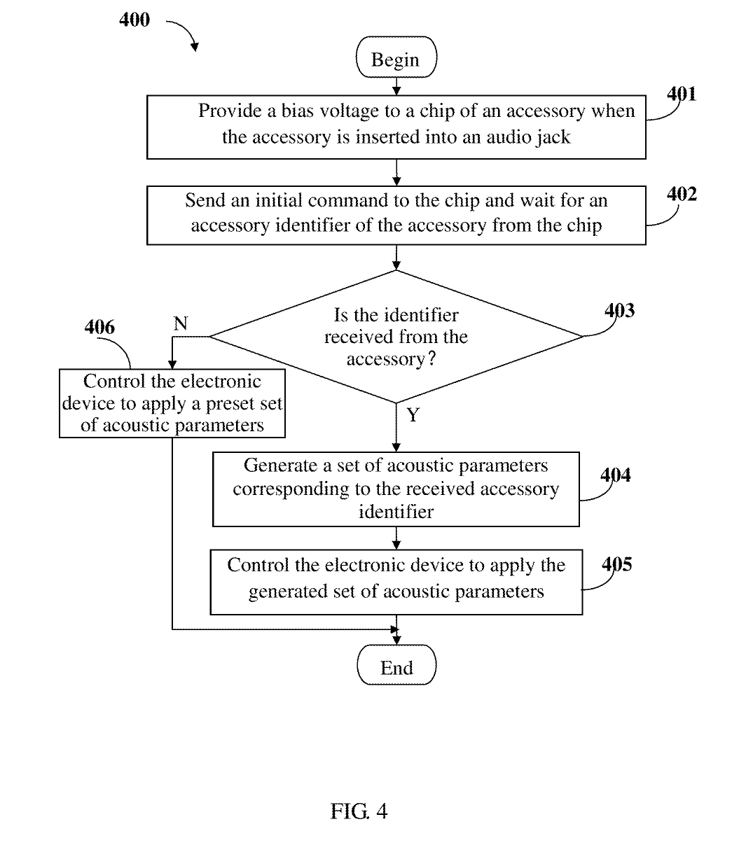

Referring to FIG. 4, a flowchart is presented in accordance with an example embodiment. An example method 400 is provided to detect an accessory of the electronic device by way of example, as there are a variety of ways to carry out the method. The example method 400 described below can be carried out using the configurations illustrated in FIGS. 1-3, for example, and various elements of these figures are referenced in explaining the example method 400. Each block shown in FIG. 4 represents one or more processes, methods, or subroutines, carried out in the example method 400. Furthermore, the illustrated order of blocks is illustrative only and the order of the blocks can be changed. Additional blocks can be added or fewer blocks can be utilized without departing from this disclosure. The example method 400 can begin at block 401.

At block 401, when the accessory 2 is inserted into the audio jack 10, a powering module provides a bias voltage to the chip 21 of the accessory 2 for powering the chip 21.

At block 402, a sending module sends an initialization command to the chip 21, and a receiving module waits for an accessory identifier (AID) of the accessory 2 from the chip 21. The initialization command can have a preset format. After the chip 21 receives the initialization command from the electronic device 1, the chip 21 can read the AID of the accessory 2 and feed back the AID to the processor 12 of the electronic device 1.

At block 403, a determination module determines whether the electronic device 1 receives the AID of the accessory 2 from the chip 21. If the electronic device 1 receives the AID from the chip 21 within a preset time period (for example, 20 milliseconds), the determination module determines that the electronic device 1 receives the AID of the accessory 2 from the chip 21, and block 404 is implemented. If the electronic device 1 does not receive the AID from the chip 21 within the preset time period, the determination module determines that the electronic device 1 does not receive the AID of the accessory 2 from the chip 21, and block 405 is implemented.

At block 404, an adjustment module generates a set of acoustic parameters corresponding to the received AID of the accessory 2, and controls the electronic device 1 to apply the generated set of acoustic parameters. In at least one embodiment, the adjustment module searches for a specified AID matching (for example, be the same as) the received AID in the storage device 13. If the adjustment module finds the specified AID in the storage device 13, the adjustment module selects the set of acoustic parameters corresponding to the specified AID for generating the set of acoustic parameters corresponding to the received AID. If the adjustment module does not find such specified AID in the storage device 13, the adjustment module selects a default set of acoustic parameters for generating the set of acoustic parameters corresponding to the received AID. The electronic device 1 applies the generated set of acoustic parameters to process audio data of the electronic device 1.

At block 405, the adjustment module controls the electronic device 1 to apply a preset set of acoustic parameters. The electronic device 1 applies the preset set of acoustic parameters to process audio data of the electronic device 1.

All of the processes described above can be embodied in, and fully automated via, functional code modules executed by one or more general purpose processors such as the processor 12. The code modules can be stored in any type of non-transitory readable medium or other storage device such as the storage device 13. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A method for detecting an accessory of an electronic device, the method being executed by at least one processor of the electronic device, the method comprising:
providing a bias voltage to power a chip of the accessory when the accessory is inserted into an audio jack of the electronic device;
sending an initialization command with a preset format to the chip,
receiving an accessory identifier (AID) of the accessory from the chip;
generating a set of acoustic parameters corresponding to the received AID of the accessory when the electronic device receives the AID of the accessory from the chip; and
controlling the electronic device to apply the generated set of acoustic parameters.

2. The method of claim 1, wherein the initialization command is sent to the chip for controlling the chip to read the AID of the accessory stored in the chip, and to feed back the AID to the at least one processor of the electronic device.

3. The method of claim 1, further comprising:
determining whether the electronic device receives the AID of the accessory from the chip;
determining that the electronic device receives the AID of the accessory from the chip when the electronic device receives the AID from the chip within a preset time period; and
determining that the electronic device does not receive the AID of the accessory from the chip when the electronic device does not receive the AID from the chip within the preset time period.

4. The method of claim 1, further comprising:
storing AIDs of a plurality of accessories with different models in a storage device of the electronic device;
storing a plurality of sets of acoustic parameters in the storage device, wherein each of the set of the acoustic parameters is corresponding to one of the AIDs in the storage device; and
generating the set of acoustic parameters corresponding to the received AID of the accessory according to the AIDs and the sets of the acoustic parameters in the storage device.

5. The method of claim 4, wherein the set of acoustic parameters corresponding to the received AID of the accessory is generated by:
searching for a specified AID matching the received AID in the storage device;
selecting the set of acoustic parameters corresponding to the specified AID as the set of acoustic parameters corresponding to the received AID when the specified AID is found from the storage device; and
selecting a default set of acoustic parameters as the set of acoustic parameters corresponding to the received AID when no specified AID matching the received AID is found in the storage device.

6. The method of claim 1, wherein the accessory is a headset.

7. A non-transitory computer-readable medium having stored thereon instructions that, when executed by at least one processor of an electronic device, causing the least one processor to perform a method for detecting an accessory of the electronic device, the method comprising:
providing a bias voltage to power a chip of the accessory when the accessory is inserted into an audio jack of the electronic device;
sending an initialization command with a preset format to the chip, and waiting for an accessory identifier (AID) of the accessory from the chip;
generating a set of acoustic parameters corresponding to the received AID of the accessory when the electronic device receives the AID of the accessory from the chip; and
controlling the electronic device to apply the generated set of acoustic parameters.

8. The non-transitory computer-readable medium of claim 7, wherein the initialization command is sent to the chip for controlling the chip to read the AID of the accessory stored in the chip, and to feed back the AID to the at least one processor of the electronic device.

9. The non-transitory computer-readable medium of claim 8, wherein the method further comprises:
determining whether the electronic device receives the AID of the accessory from the chip;
determining that the electronic device receives the AID of the accessory from the chip when the electronic device receives the AID from the chip within a preset time period; and
determining that the electronic device does not receive the AID of the accessory from the chip when the electronic device does not receive the AID from the chip within the preset time period.

10. The non-transitory computer-readable medium of claim 8, wherein the method further comprises:
storing AIDs of a plurality of accessories with different models in a storage device of the electronic device; and
storing a plurality of sets of acoustic parameters in the storage device, wherein each of the set of the acoustic parameters is corresponding to one of the AIDs in the storage device; and
generating the set of acoustic parameters corresponding to the received AID of the accessory according to the AIDs and the sets of the acoustic parameters in the storage device.

11. The non-transitory computer-readable medium of claim 10, wherein the set of acoustic parameters corresponding to the received AID of the accessory is generated by:
searching for a specified AID matching the received AID in the storage device;
selecting the set of acoustic parameters corresponding to the specified AID as the set of acoustic parameters corresponding to the received AID when the specified AID is found from the storage device; and
selecting a default set of acoustic parameters as the set of acoustic parameters corresponding to the received AID when no specified AID matching the received AID is found in the storage device.

12. The non-transitory computer-readable medium of claim 7, wherein the accessory is a headset.

13. An electronic device comprising:
an audio jack connected to an accessory;
at least one processor; and
a storage device that stores one or more programs which, when executed by the at least one processor, cause the at least one processor to:
provide a bias voltage to power a chip of the accessory when the accessory is inserted into an audio jack of the electronic device;
send an initialization command with a preset format to the chip, and wait for an accessory identifier (AID) of the accessory from the chip;
generate a set of acoustic parameters corresponding to the received AID of the accessory when the electronic device receives the AID of the accessory from the chip; and
control the electronic device to apply the generated set of acoustic parameters.

14. The electronic device of claim 13, wherein the at least one processor sends the initialization command to the chip for controlling the chip to read the AID of the accessory stored in the chip, and to feed back the AID to the at least one processor of the electronic device.

15. The electronic device of claim 14, wherein the at least one processor further:
determines whether the electronic device receives the AID of the accessory from the chip;
determines that the electronic device receives the AID of the accessory from the chip when the electronic device receives the AID from the chip within a preset time period; and
determines that the electronic device does not receive the AID of the accessory from the chip when the electronic device does not receive the AID from the chip within the preset time period.

16. The electronic device of clam 14, wherein the storage device stores AIDs of a plurality of accessories with different models and a plurality of sets of acoustic parameters, wherein each of the set of the acoustic parameters is corresponding to one of the AIDs in the storage device, wherein the set of acoustic parameters corresponding to the received AID of the accessory is generated according to the AIDs and the sets of the acoustic parameters in the storage device.

17. The electronic device of claim 16, wherein the set of acoustic parameters corresponding to the received AID of the accessory is generated by:
searching for an specified AID matching the received AID in the storage device;
selecting the set of acoustic parameters corresponding to the specified AID as the set of acoustic parameters corresponding to the received AID when the specified AID is found from the storage device; and
selecting a default set of acoustic parameters as the set of acoustic parameters corresponding to the received AID when no specified AID matching the received AID is found in the storage device.

18. The electronic device of claim 13, wherein the accessory is a headset.
